(19) United States
(12) Patent Application Publication
(10) Pub. No.: US 2017/0326516 A1
(43) Pub. Date: Nov. 16, 2017

(54) APPARATUSES AND METHODS FOR IMPROVED MIXING

(71) Applicant: Tetra Laval Holdings & Finance S.A., Pully (CH)

(72) Inventors: Hans Henrik MORTENSEN, Noerresundby (DK); Jan Fauerholt JENSEN, Saeby (DK); Palle Bach JENSEN, Kongerslev (DK); Frederik LARSEN, Dronninglund (DK)

(21) Appl. No.: 15/533,854

(22) PCT Filed: Nov. 30, 2015
(86) PCT No.: PCT/EP2015/078040

§ 371 Date: Jun. 7, 2017

(30) Foreign Application Priority Data
Dec. 8, 2014 (SE) 1451495-4

(51) Int. Cl. B01F 13/10; B01F 3/10; B01F 3/14; B01F 7/30; B01F 7/16; B01F 3/08; B01F 5/10; B01F 7/00; B01F 13/00

(52) U.S. Cl. CPC B01F 13/1027; B01F 7/00208; B01F 3/10; B01F 3/14; B01F 7/30; B01F 7/166; B01F 7/164; B01F 3/0807; B01F 5/106; B01F 7/00; B01F 13/00; B01F 2215/0014

(57) ABSTRACT

An apparatus for mixing comprising a vessel 302 for holding a product comprising a liquid base and an ingredient, a rotor 304 for providing a first flow 306 of said product inside said vessel and a double agitator for providing a second flow 312 of said product inside said vessel. The double agitator comprises a first agitator 308 arranged to rotate in an outer section of said vessel, and a second agitator 310 arranged to rotate in an inner section of said vessel.

### TECHNICAL FIELD

Generally it is presented apparatuses and methods related to the field of mixing. More particularly, the apparatuses and methods are related to so-called high shear mixing.

### BACKGROUND

Today when producing high viscous products, such as ketchup or mayonnaise, high shear mixing is often used. High shear mixing differs from other mixing in that high shear mixing can form mixtures of ingredients that do not naturally mix, such as mixing oil and water into an emulsion. In order to form this high shear a rotor, also known as impeller, can be used in combination with a stator. In one example of a high shear mixer, Tetra Pak High Shear Mixer™, the rotor is placed in a bottom part of a vessel and the stator provided with openings is placed such that this surrounds the rotor.

For high viscous products, such as mayonnaise, it is today common to use an external pump to make sure that sufficient transportation flow is achieved inside the vessel. Since an extra pump increases the cost for the equipment as well as the operational cost, due to that the pump and the additional piping increases product losses, it is in the interest of food producers to find a new way of mixing high viscous products more cost efficiently.

### SUMMARY

Accordingly, the present invention preferably seeks to mitigate, alleviate or eliminate one or more of the above-identified deficiencies in the art and disadvantages singly or in any combination and solves at least the above mentioned problems.

According to a first aspect it is provided an apparatus for mixing, said apparatus comprising a vessel for holding a product comprising a liquid base and an ingredient, a rotor for providing a first flow of said product inside said vessel, a double agitator for providing a second flow of said product inside said vessel, wherein said double agitator comprises a first agitator arranged to rotate in an outer section of said vessel, and a second agitator arranged to rotate in an inner section of said vessel.

The ingredient may be a liquid ingredient or a solid ingredient.

The first flow and said second flow may coincide at least partly.

The first flow and said second flow may form a transportation flow providing for that said product in said outer section of said vessel is transported towards a top of said vessel, and for that said product in said inner section is transported towards a bottom of said vessel.

The first agitator and said second agitator may be individually controlled.

The first agitator and said second agitator may counter-rotate.

The second agitator may be arranged to scrape an inner wall of said tank during rotation.

The apparatus may further comprise a stator at least partly surrounding said rotor.

The apparatus may further comprise a control device provided with a number of programs for different products, each program comprising instructions on rotational speed for said first agitator, said second agitator and/or said rotor, respectively.

The first agitator and/or said second agitator may be driven by a motor provided with a planetary gear.

According to a second aspect it is provided a method for forming a product, said method comprising placing a liquid base and an ingredient in said vessel, mixing said liquid base and said ingredient into a mixture by providing a first flow of said product in said vessel by using a rotor, providing a second flow of said product inside said vessel by using a double agitator comprising a first agitator rotating in an outer section of said vessel and a second agitator rotating in an inner section of said vessel.

The first flow and said second flow may coincide at least partly.

The first agitator, said second agitator and said rotor may be individually controlled.

The first agitator and said second agitator may counter-rotate.

The method may further comprise scraping an inner wall of said tank during rotation by using said second agitator.

The step of mixing said liquid base and said ingredient into a mixture may further comprise forming a shear between said liquid base and said ingredient by using said rotor and a stator, said stator at least partly surrounding said rotor.

The method may further comprise adding particles to said mixture, and stirring said particles and said mixture by using at least one of said first agitator and said second agitator.

The first and/or said second agitator may move during operation in a non-concentric path.

According to a third aspect it is provided a processing line comprising an apparatus according the first aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates an example of an arrangement, comprising a tank with a stirring device, used for mayonnaise production.

FIG. 2 illustrates an example of a two-step approach for producing products comprising an emulsion and vegetables, such as cole slaw.

FIG. 3 illustrates schematically a mixer provided with a double agitator.

### DETAILED DESCRIPTION OF PREFERRED EMBODIMENTS

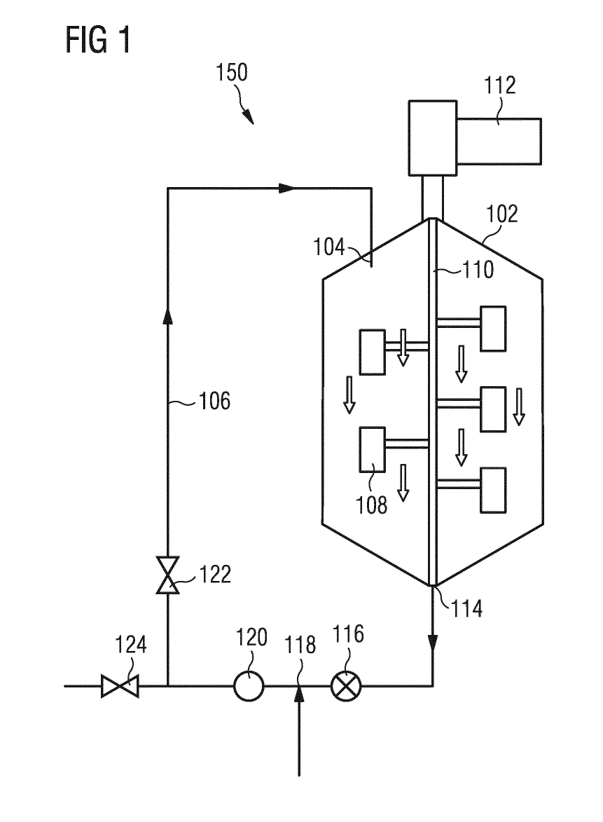

FIG. 1 illustrates an arrangement 100 used for producing mayonnaise. Ingredients are added and transferred to a tank 102 via an inlet 104 connected to a pipe 106. In the tank 102, stirring panels 108 mounted on an shaft 110 provide for that the ingredients are stirred together. In order to rotate the shaft 110 a motor 112 is used. Most often the inlet 104 is placed in an upper portion of the tank 102 and an outlet 114 is placed in a bottom portion of the tank. In order to provide for that the ingredients are able to circulate through the tank a number of times until desired product properties are achieved, a pump 116 placed after the outlet 114 is used.

Oil is added in a node 118. In order to provide for that a correct amount of oil is added this may be adjusted relative to the flow. After the oil has been added a mixer 120, such as a mixing valve, is used for partly mixing the oil with the other ingredients.

In order to control if the ingredients should be transported back to the tank for further stirring or to a next step of a processing line, a first valve 122 and a second valve 124 may be used. The first valve 122 is placed on the pipe 106 and the second valve 124 is placed on a pipe leading to e.g. a filling machine for filling the mayonnaise in packages. By having the first valve 122 opened and the second valve 124 closed the ingredients are fed back to the tank, and by having the first valve 122 closed and the second valve 124 opened the product is fed to e.g. the filling machine.

A drawback with the arrangement 100 illustrated in FIG. 1 is that a pump is required for re-circulating a mixture of the ingredients and the oil until desired product properties are achieved. In addition to that the pump is required, a further drawback is that product losses will increased due to the pipe 106 used when re-circulating the mixture.

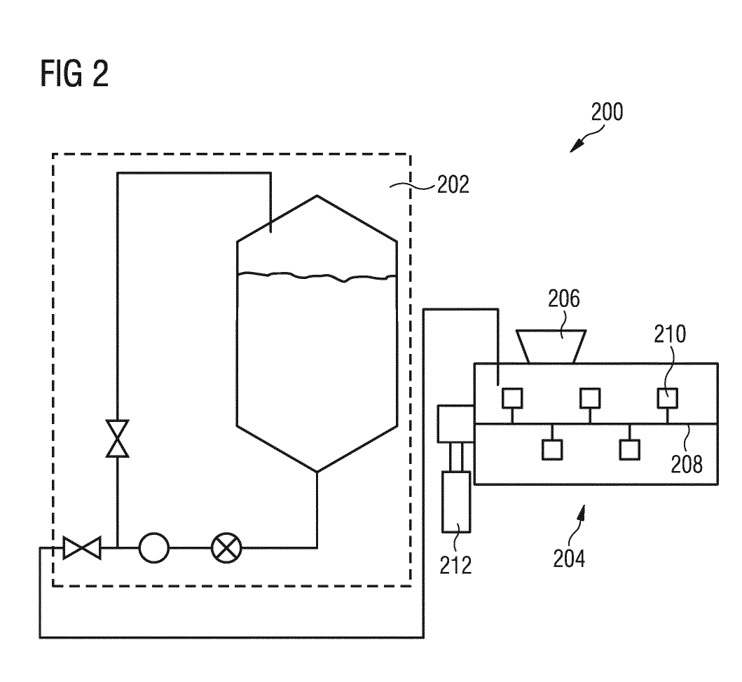

FIG. 2 illustrates two parts of a production line 200 for cole slaw or other products comprising an emulsion and vegetables.

In a first part 202 the emulsion is formed, e.g. by using the arrangement illustrated in FIG. 1. After having formed the emulsion this is transferred to a second part comprising a stirrer 204. The stirrer can be provided with an inlet 206 for vegetables, a shaft 208 provided with a number of stirring panels 210. The shaft 208 may be rotated by using a motor 212.

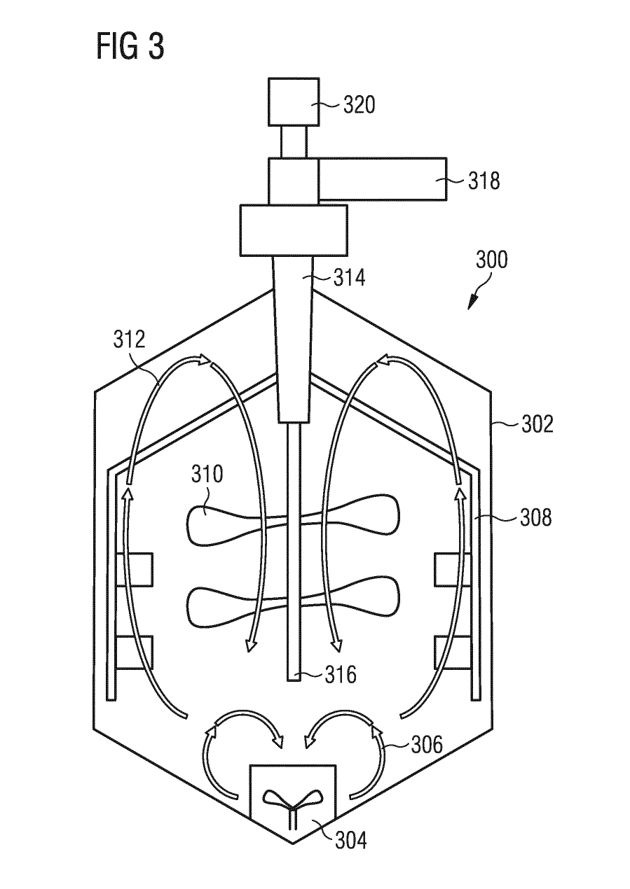

FIG. 3 illustrates a mixer 300 provided with a double shaft agitator. The mixer 300 can comprise a vessel 302 provided with a mixing unit 304 in its lower part. The mixing unit 304 may be a high shear mixing unit. This high shear mixing unit may comprise a rotor, such as an impeller, and a stator. The stator may be formed such that this surrounds the rotor, and may comprise a number of openings in order to provide for improved high shear mixing.

The mixing unit 304 may be designed such that this in operation forms a first flow 306 inside said vessel 302. If the vessel is filled with a high viscous product, such as mayonnaise, the first flow 306 will, as illustrated in FIG. 3, appear in the lower part of the vessel.

In order to provide for that a transport flow is formed such that also the product in the upper part of the vessel is transported down to the mixing unit 304 a double agitator can be provided. The double agitator can comprise a first agitator 308 and a second agitator 310. The first agitator 308 may comprise one or several elements extending to an outer section of the vessel. In order to form a flow of the product, for instance upwards, the element may be provided with panels.

The first agitator 308 may be arranged to scrape the inside of the vessel when being rotated. An advantage of this is that if the vessel is provided with a heating/cooling jacket the first agitator will provide for an improved thermal transfer since the circulation of product being close to the inside of the vessel is improved. Another advantage is that the risk of overheating product close to the inside of the vessel is reduced. This in turn may imply that the cleaning time for the vessel can be reduced.

The second agitator 310 may be placed centrally in the vessel as illustrated in FIG. 3. The second agitator may be provided with panels in order to provide for that a desired flow inside the vessel can be formed. As illustrated in FIG. 3, the second agitator 310 may have impeller-like panels.

The panels of the first and second agitator may be formed such that a second flow 312 inside the vessel is formed. In order to achieve this flow the first and second agitator may counter-rotate.

The first flow 306 and the second flow 312 may be such that these coincide at least partly. A positive effect of this is that it is made sure for high viscous products, such as mayonnaise, that also the product in the upper part of the vessel is transported to the mixing unit 304 and there being subjected to mixing. This in turn has the effect that the product does not have to be re-circulated outside the vessel and hence that no external pump or piping is needed.

In order to provide for that the first agitator 308 and the second agitator 310 can counter-rotate, the first agitator 308 may comprise a first shaft 314 and the second agitator 310 may comprise second shaft 316, wherein the first shaft 314 is hollow and the second shaft 316 is placed in its upper section inside said first shaft. By having this arrangement, the first shaft 314 may be rotated by a first motor 318, for instance a gear motor, and the second shaft 316 may be rotated by a second motor 320, such as a gear motor, and by having individual motors these can be controlled individually, for instance, such that they counter-rotate. In order to achieve a non-concentric path for one or both of the agitators planetary gears can be used.

Even though not illustrated in FIG. 3, an inlet for oil or other ingredients may be present in the vessel.

By having the mixer provided with the double agitator as illustrated in FIG. 3 the two-step approach illustrated in FIG. 2 can be avoided. After having formed the emulsion in the mixer 300 the vegetables can be added via an inlet, not illustrated in FIG. 3, and stirred into the emulsion by using the first and/or the second agitator. An advantage of this flexibility is that less equipment is necessary for producing this kind of product.

The invention has mainly been described above with reference to a few embodiments. However, as is readily appreciated by a person skilled in the art, other embodiments than the ones disclosed above are equally possible within the scope of the invention, as defined by the appended patent claims.

1. An apparatus for mixing, said apparatus comprising
a vessel for holding a product comprising a liquid base and an ingredient,
a rotor for providing a first flow of said product inside said vessel,
a double agitator for providing a second flow of said product inside said vessel,
wherein said double agitator comprises
a first agitator arranged to rotate in an outer section of said vessel, and
a second agitator arranged to rotate in an inner section of said vessel.

2. The apparatus according to claim 1, wherein said first flow and said second flow coincide at least partly.

3. The apparatus according to claim 2, wherein said first flow and said second flow form a transportation flow providing for that said product in said outer section of said vessel is transported towards a top of said vessel, and for that said product in said inner section is transported towards a bottom of said vessel.

4. The apparatus according to claim 1, wherein said first agitator and said second agitator are individually controlled.

5. The apparatus according to claim 1, wherein said first agitator and said second agitator counter-rotate.

6. The apparatus according to claim 1, wherein said second agitator is arranged to scrape an inner wall of said tank during rotation.

7. The apparatus according to claim 1, further comprising
a stator at least partly surrounding said rotor.

8. The apparatus according to claim 1, further comprising a control device provided with a number of programs for different products, each program comprising instructions on rotational speed for said first agitator, said second agitator and/or said rotor, respectively.

9. The apparatus according to claim 1, wherein said first agitator and/or said second agitator are driven by a motor provided with a planetary gear.

10. A method for forming a product, said method comprising
placing a liquid base and an ingredient in said vessel,
mixing said liquid base and said ingredient into a mixture by
providing a first flow of said product in said vessel by using a rotor,
providing a second flow of said product inside said vessel by using a double agitator comprising a first agitator rotating in an outer section of said vessel and a second agitator rotating in an inner section of said vessel.

11. The method according to claim 10, wherein said first flow and said second flow coincide at least partly.

12. The method according to claim 10, wherein said first agitator, said second agitator and said rotor are individually controlled.

13. The method according to claim 10, wherein said first agitator and said second agitator counter-rotate.

14. The method according to claim 10, further comprising
scraping an inner wall of said tank during rotation by using said second agitator.

15. The method according to claim 10, wherein said step of mixing said liquid base and said ingredient into a mixture further comprising
forming a shear between said liquid base and said ingredient by using said rotor and a stator, said stator at least partly surrounding said rotor.

16. The method according to claim 10, further comprising
adding particles to said mixture,
stirring said particles and said mixture by using at least one of said first agitator and said second agitator.

17. The method according to claim 10, wherein said first and/or said second agitator moves during operation in a non-concentric path.

18. A processing line comprising an apparatus according to claim 1.
